(19) United States
(12) Patent Application Publication
(10) Pub. No.: US 2018/0118014 A1
(43) Pub. Date: May 3, 2018

(54) Cooling System For Hybrid Electric Drivetrain

(71) Applicant: Deere & Company, Moline, IL (US)

(72) Inventor: Paul A. Wantschik, Dubuque, IA (US)

(21) Appl. No.: 15/335,823

(22) Filed: Oct. 27, 2016

(51) Int. Cl. B60K 11/00; B60K 1/00

(52) U.S. Cl. CPC B60K 11/00; B60K 1/00; B60Y 2306/05; B60K 2001/006; B60Y 2200/41; B60L 2240/36; B60Y 2400/89

(57) ABSTRACT

A cooling system for a hybrid electric work vehicle. The hybrid electric work vehicle having a power electronic device and a drivetrain device. The cooling system comprises a radiator. The power electronic device defines a first fluid path. The drivetrain device defines a second fluid path. A fluid pump is provided for directing a fluid through the radiator, the first fluid path, and the second fluid path to dissipate heat.

### FIELD OF THE DISCLOSURE

The present disclosure generally relates to hybrid electric work vehicles, and more particularly to a system and method for cooling a hybrid electric drivetrain of the hybrid electric work vehicle.

### BACKGROUND OF THE DISCLOSURE

In order to cool power electronics and to cool drivetrain devices on a hybrid electric work vehicle, separate cooling systems are commonly used.

### SUMMARY OF THE DISCLOSURE

In one embodiment, a cooling system for a hybrid electric work vehicle is disclosed. The hybrid electric work vehicle has a power electronic device and a drivetrain device. The cooling system comprises a radiator. The power electronic device defines a first fluid path. The drivetrain device defines a second fluid path. A fluid pump is provided for directing a fluid through the radiator, the first fluid path, and the second fluid path to dissipate heat.

In another embodiment, a hybrid electric work vehicle is disclosed. The hybrid electric work vehicle comprises a power electronic device. A drivetrain device is provided. A cooling system is provided for dissipating heat from the work vehicle. The cooling system comprises a radiator and a first fluid path defined by the power electronic device. A second fluid path is defined by the drivetrain device. A fluid pump is provided for directing a fluid through the radiator, the first fluid path, and the second fluid path.

In yet another embodiment, a method for cooling a hybrid electric work vehicle is disclosed. The hybrid electric work vehicle has a power electronic device and a drivetrain device. The method comprises providing a radiator and providing a first fluid path defined by the power electronic device. The method also comprises providing a second fluid path defined by the drivetrain device and directing a fluid through the radiator, the first fluid path, and the second fluid path to dissipate heat.

Other features and aspects will become apparent by consideration of the detailed description and accompanying drawings.

### BRIEF DESCRIPTION OF THE DRAWINGS

FIG. 1 is a perspective view of a crawler according to one embodiment.

FIG. 2 is a perspective view of a wheel loader according to another embodiment.

FIG. 3 is a schematic of a cooling system of a hybrid electric work vehicle according to yet another embodiment.

FIG. 4 is a schematic of a cooling system of a hybrid electric work vehicle according to another embodiment.

FIG. 5 is a schematic of an illustrative method for cooling a hybrid electric work vehicle.

FIG. 6 is a schematic of a cooling system of a hybrid electric work vehicle according to yet another embodiment.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

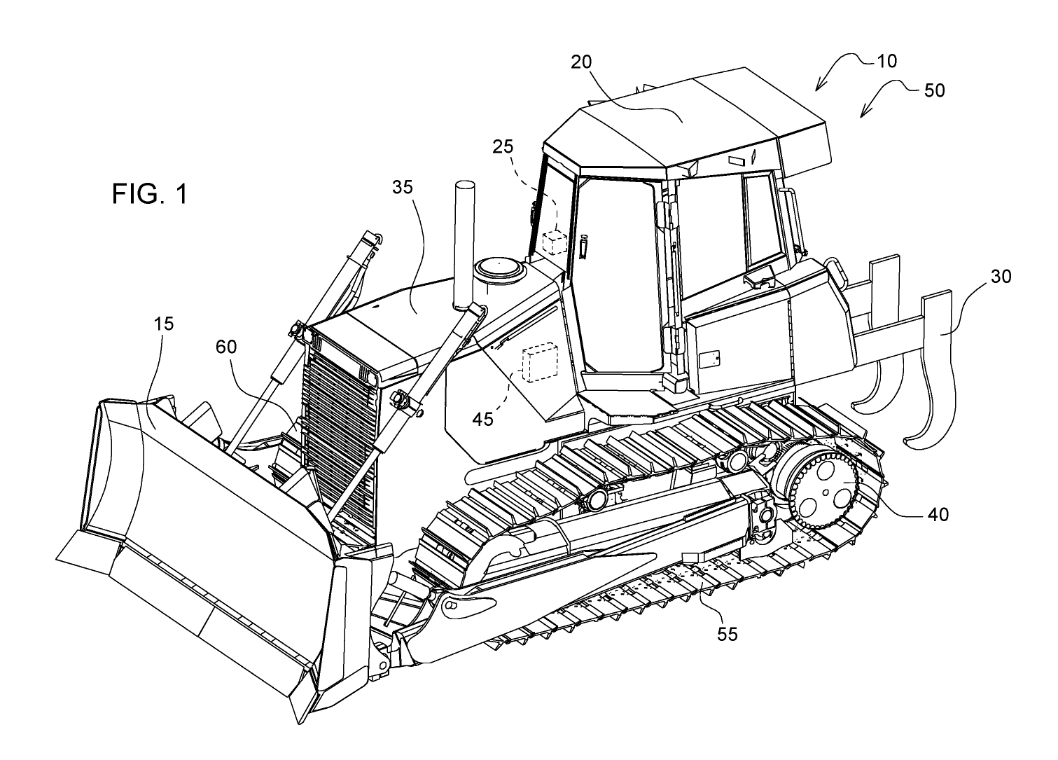

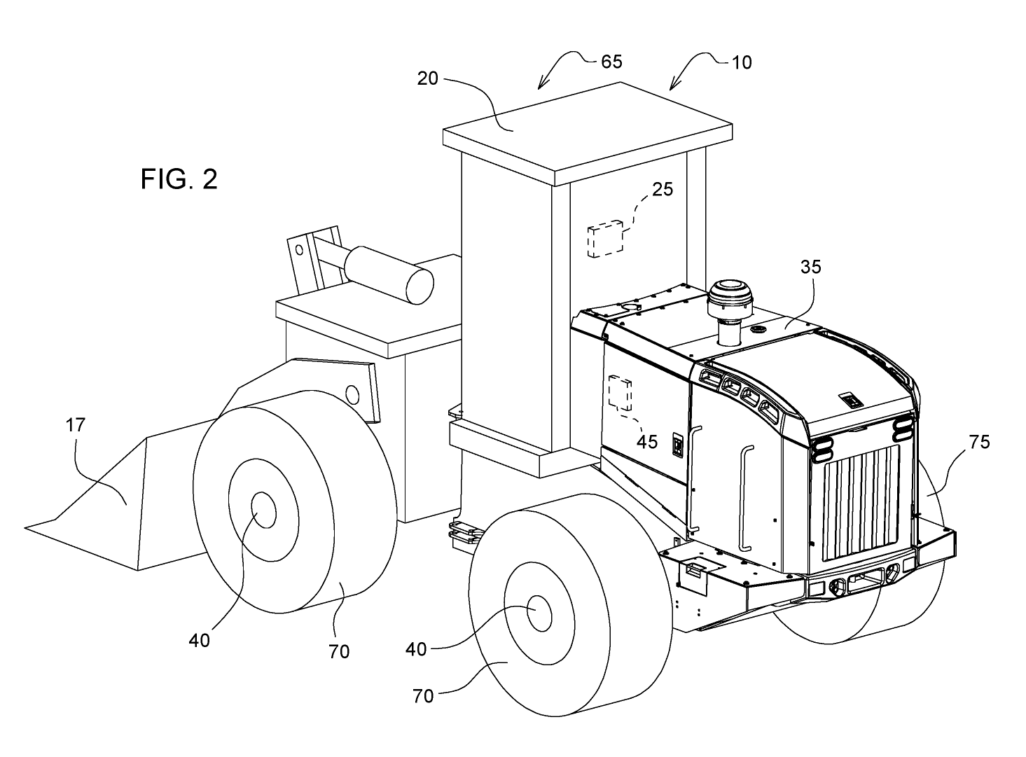

FIGS. 1 and 2 illustrate a hybrid electric work vehicle 10 having a blade 15 (FIG. 1) or bucket 17 (FIG. 2), an operator station 20 having an operator interface 25, a ripper 30 (FIG. 1), and an engine 35. The hybrid electric work vehicle 10 may be any work vehicle that may utilize a hybrid electric drivetrain system, such as a crawler, a wheel loader, an articulated dump truck, a backhoe loader, an excavator, a skid steer, a motor grader, a skidder, a harvester, a feller buncher, a forwarder, and a knuckleboom loader, to name a few examples.

The hybrid electric work vehicle 10 may be controlled by an operator located in the operator station 20. The operator may command the hybrid electric work vehicle 10 to move forward, move backward, and turn. In the case of the hybrid electric work vehicle 10, those commands are sent to modular independent electric wheel drives 40, which may have electronic traction control, that turn tracks or wheels. The modular independent electric wheel drives 40 may be brushless AC electric motors. The modular independent electric wheel drives 40 may be powered by an electric generator 45 that is driven by the engine 35. The electric generator 45 may be a brushless AC electric generator. The engine 35 may be a diesel engine.

With reference to FIG. 1, the blade 15 is positioned at a front of the hybrid electric work vehicle 10 and may be attached to the hybrid electric work vehicle 10 in a number of different manners. In this embodiment, the blade 15 is attached to the hybrid electric work vehicle 10 through a linkage which includes a series of pinned joints, structural members, and hydraulic cylinders. This configuration allows the blade 15 to be moved up and down relative to the ground, rotate around a vertical axis (i.e., an axis normal to the ground), rotate around a longitudinal axis (e.g., a fore-aft axis of the hybrid electric work vehicle 10), and rotate around a lateral axis of the hybrid electric work vehicle 10 (i.e., a left-right axis of the hybrid electric work vehicle 10). These degrees of freedom permit the blade 15 to engage the ground at multiple depths and cutting angles. Alternative embodiments may involve blades with greater degrees of freedom, such as those found on some motor graders, and those with fewer degrees of freedom, such as “pushbeam” style blades found on some crawlers and blades which may only be raised, lowered, and rotated around a vertical axis as found on some excavators and skidders.

The operator may command movement of the blade 15 from the operator station 20. In the case of the hybrid electric work vehicle 10, those commands are sent, including mechanically, hydraulically, and/or electrically, to a hydraulic control valve. The hydraulic control valve receives pressurized hydraulic fluid from a hydraulic pump, and selectively sends such pressurized hydraulic fluid to a system of hydraulic cylinders based on the operator's commands. The hydraulic cylinders, which in this case are double-acting, in the system are extended or retracted by the pressurized fluid and thereby actuate the blade 15.

The ripper 30 is positioned at a rear of the hybrid electric work vehicle 10 and may be attached to the hybrid electric work vehicle 10 in a number of different manners. In this embodiment, the ripper 30 is attached to the hybrid electric work vehicle 10 through a linkage which includes a series of pinned joints, structural members, and hydraulic cylinders. This configuration allows the ripper 30 to be moved up and down relative to the ground.

With continued reference to FIG. 1, the illustrated hybrid electric work vehicle 10 is a crawler 50 for moving material using the blade 15. The crawler 50 includes a left track 55 and a right track 60. As used herein, “left” and “right” refer to the left and right sides of the operator when the operator is sitting within the operator station 20 and facing the blade 15. The ripper 30 is coupled to a rear of the crawler 50.

Referring to FIG. 2, the illustrated hybrid electric work vehicle 10 is a wheel loader 65 for loading material using the bucket 17. The wheel loader 65 includes a plurality of left wheels 70 and a plurality of right wheels 75.

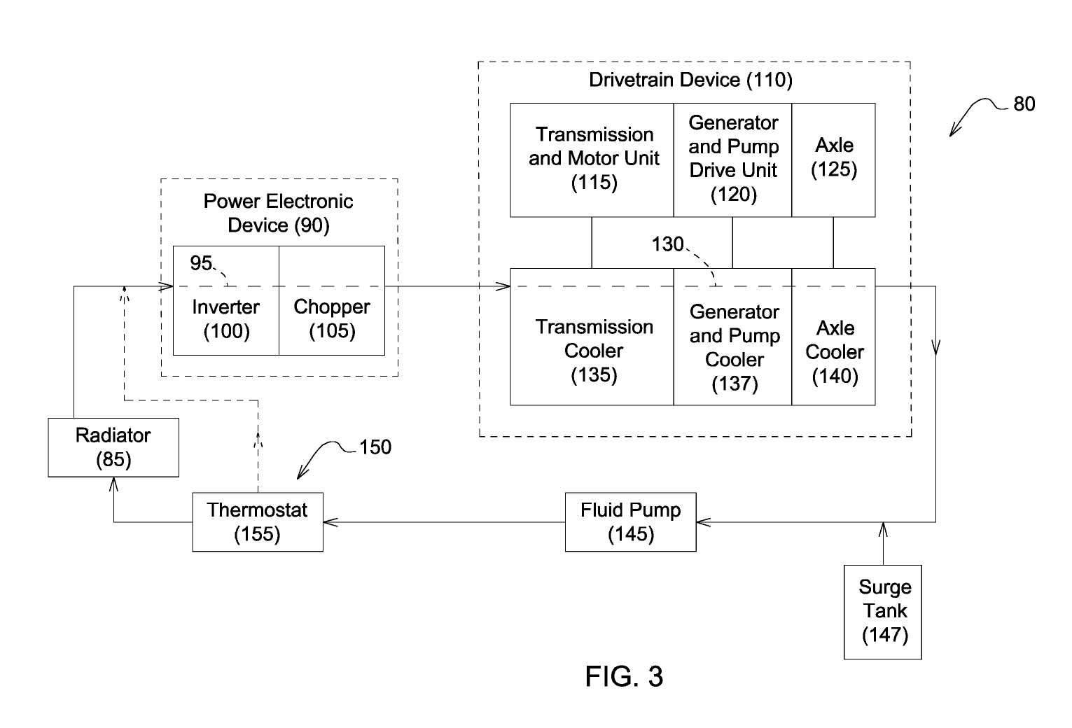

With reference to FIG. 3, the hybrid electric work vehicle 10 has a cooling system 80. The cooling system 80 includes a radiator 85.

A power electronic device 90 is provided for receiving power from the electric generator 45 and sending power to the modular independent electric wheel drive 40. During a regenerative braking operation (e.g., converting kinetic energy of a decelerating hybrid electric work machine 10 into electrical energy), the power electronic device 90 receives power from the modular independent electric wheel drive 40 and provides the power to the electric generator 45, which momentarily functions as an electric motor to assist the engine 35 in driving hydraulics pumps. The power electronic device 90 defines a first fluid path 95 to receive a fluid to dissipate heat. The power electronic device 90 may be an inverter 100 or a chopper 105 to name a few examples. The inverter 100 is an electronic device that changes direct current (DC) to alternating current (AC). The chopper 105 is an electronic switching device.

The hybrid electric work vehicle 10 includes a drivetrain device 110 that requires cooling. The drivetrain device 110 may be a transmission and motor unit 115, a generator and pump drive unit 120, an axle 125, or other drivetrain component that requires cooling. The drivetrain device 110 defines a second fluid path 130 to receive the fluid to dissipate heat. The second fluid path 130 may be a transmission cooler 135, a generator and pump cooler 137, or an axle cooler 140, to name a few examples.

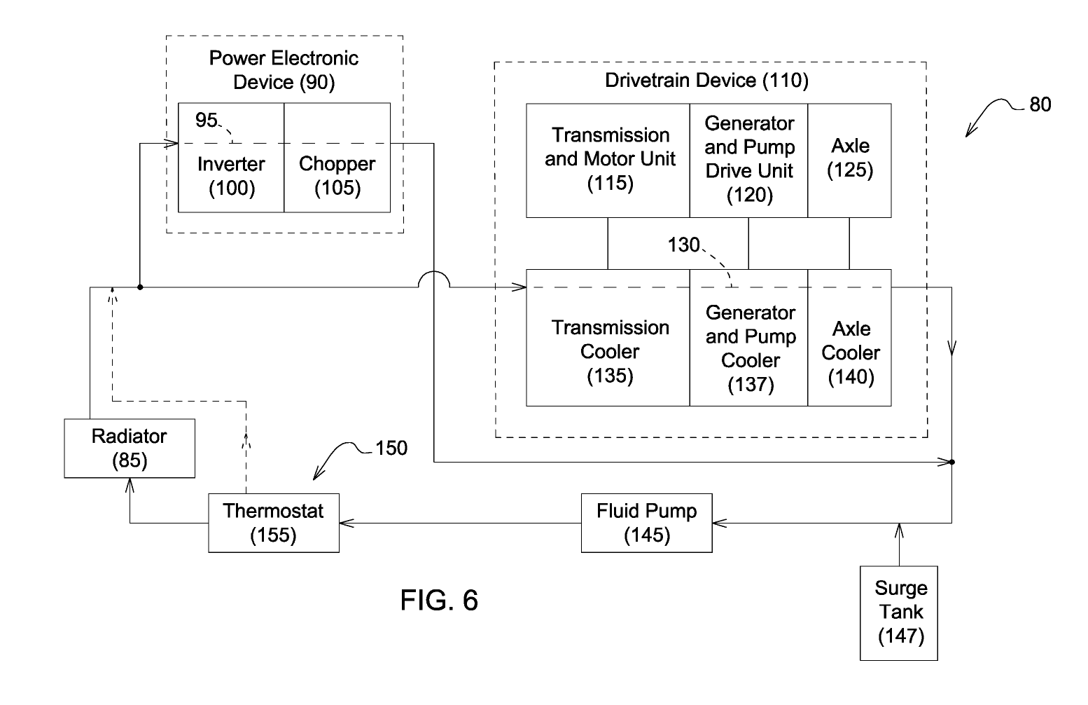

A fluid pump 145 is provided for directing the fluid through the radiator 85, the first fluid path 95, and the second fluid path 130 to dissipate heat. A surge tank 147 may be provided to supply additional fluid to the cooling system 80. The first fluid path 95 and the second fluid path 130 may be in series (FIG. 3) or in parallel (FIG. 6) depending on temperature requirements. If the power electronic device 90 and the drivetrain device 110 can be cooled with fluid at the same temperature, the parallel arrangement will work. If the power electronic device 90 and the drivetrain device 110 should be cooled with fluid at a different temperature, the series arrangement will work.

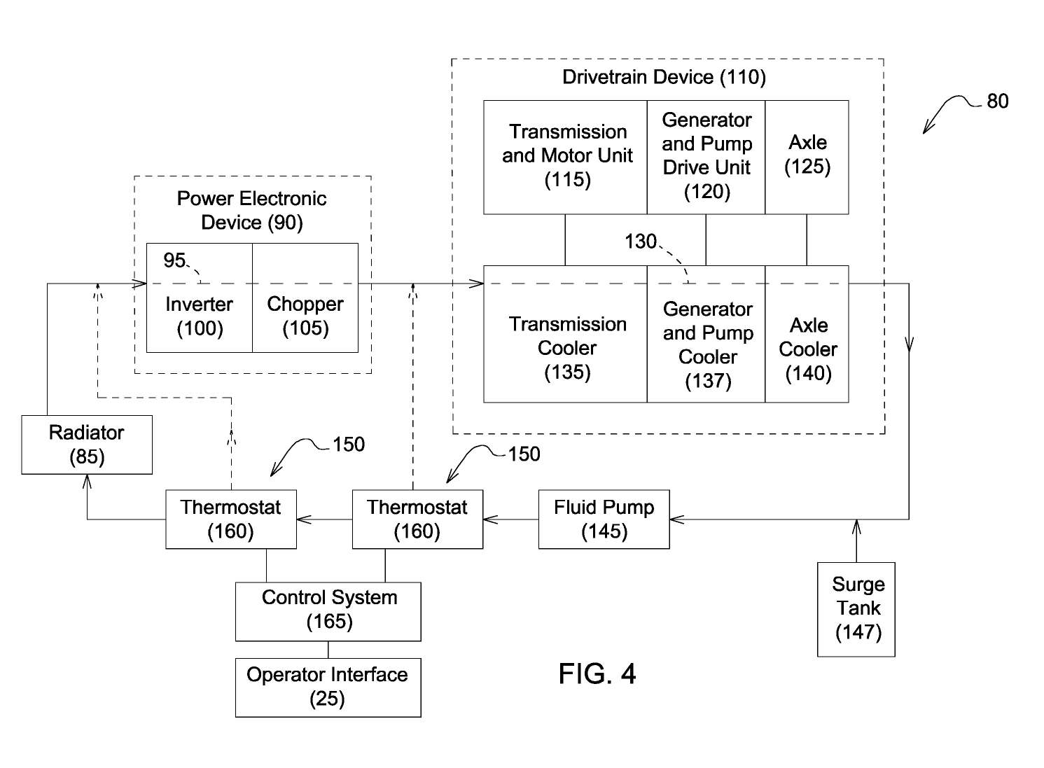

A thermostat 150 may be provided to regulate a temperature of the fluid. The thermostat 150 may be a mechanical thermostat 155 or an electronically controlled thermostat 160. In one embodiment (FIG. 3) one thermostat 150 is provided to regulate the temperature of the fluid to a temperature that is conducive for effective operation of the entire cooling system. In another embodiment (FIG. 4) two thermostats 150 are provided to provide an option to regulate the temperature of the fluid to two different temperatures (one temperature for the power electronic device 90 and one temperature for the drivetrain device 110). For example, it may be beneficial to maintain the fluid at a higher temperature for the drivetrain device 110 where cold oil can lead to higher windage losses resulting in degraded fuel economy. By allowing the oil of the drivetrain device 110 to come up to a warmer operating temperature, the windage is reduced resulting in improved fuel economy.

Referring to FIG. 4, a control system 165 may be provided to control one or more electronically controlled thermostats 160. In the case of two electronically controlled thermostats, an operator may input a threshold temperature for each electronically controlled thermostat 160 using the operator interface 25. For example, the threshold temperature would be set for the electronically controlled thermostat 160 that routes the fluid to the power electronic device 90 and the threshold temperature would be set for the electronically controlled thermostat 160 that routes the fluid to the drivetrain device 110. For the threshold temperature that is a maximum temperature, the electronically controlled thermostat 160 will route the fluid through the radiator 85 to dissipate heat until the threshold temperature is not met or exceeded. Once the threshold temperature is not met or exceeded, the electronically controlled thermostat 160 will bypass the radiator 85.

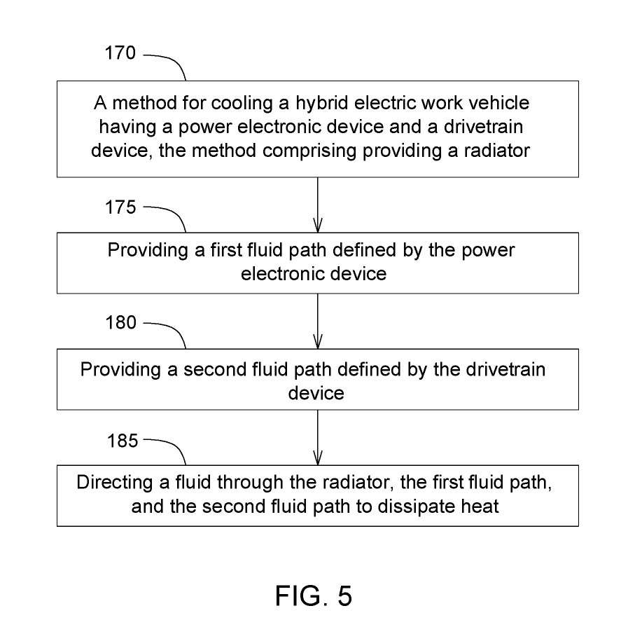

A method for cooling a hybrid electric work vehicle 10 having a power electronic device 90 and a drivetrain device 110 is illustrated in FIG. 5. In Step 170, a radiator 85 is provided. In Step 175, a first fluid path 95 is provided. The first fluid path 95 is defined by the power electronic device 90. In Step 180, a second fluid path 130 is provided. The second fluid path 130 is defined by the drivetrain device 110. In Step 185, a fluid is directed through the radiator 85, the first fluid path 95, and the second fluid path 130 to dissipate heat. In another embodiment, a thermostat 150 may be provided to control the temperature of the fluid. The power electronic device 90 may be at least one of an inverter 100 and a chopper 105. The drivetrain device 110 may be at least one of a transmission and motor unit 115, a generator and pump drive unit 120, and an axle 125.

Various features are set forth in the following claims.

What is claimed is:

1. A cooling system for a hybrid electric work vehicle having a power electronic device and a drivetrain device, the cooling system comprising:
a radiator;
the power electronic device defining a first fluid path;
the drivetrain device defining a second fluid path; and
a fluid pump for directing a fluid through the radiator, the first fluid path, and the second fluid path to dissipate heat.

2. The cooling system of claim 1, further comprising a thermostat for regulating a temperature of the fluid.

3. The cooling system of claim 2, wherein the thermostat is at least one of a mechanical thermostat and an electronically controlled thermostat.

4. The cooling system of claim 1, wherein the power electronic device is at least one of an inverter and a chopper.

5. The cooling system of claim 1, wherein the drivetrain device is at least one of a transmission and motor unit, a generator and pump drive unit, and an axle.

6. The cooling system of claim 1, wherein the drivetrain device is a transmission and motor unit and the second fluid path is a transmission cooler.

7. The cooling system of claim 1, where in the drivetrain device is an axle and the second fluid path is an axle cooler.

8. The cooling system of claim 1, wherein the hybrid electric work vehicle is at least one of a loader and a crawler.

9. A hybrid electric work vehicle comprising:
a power electronic device;
a drivetrain device; and
a cooling system for dissipating heat from the work vehicle, the cooling system comprising;
a radiator;
a first fluid path defined by the power electronic device;
a second fluid path defined by the drivetrain device; and
a fluid pump for directing a fluid through the radiator, the first fluid path, and the second fluid path.

10. The hybrid electric work vehicle of claim 9, further comprising a thermostat for regulating a temperature of the fluid.

11. The hybrid electric work vehicle of claim 10, wherein the thermostat is at least one of a mechanical thermostat and an electronically controlled thermostat.

12. The hybrid electric work vehicle of claim 9, wherein the power electronic device is at least one of an inverter and a chopper.

13. The hybrid electric work vehicle of claim 9, wherein the drivetrain device is at least one of a transmission and motor unit, a generator and pump drive unit, and an axle.

14. The hybrid electric work vehicle of claim 9, wherein the drivetrain device is a transmission and motor unit and the second fluid path is a transmission cooler.

15. The hybrid electric work vehicle of claim 9, where in the drivetrain device is an axle and the second fluid path is an axle cooler.

16. The hybrid electric work vehicle of claim 9, wherein the hybrid electric work vehicle is at least one of a loader and a crawler.

17. A method for cooling a hybrid electric work vehicle having a power electronic device and a drivetrain device, the method comprising:
providing a radiator;
providing a first fluid path defined by the power electronic device;
providing a second fluid path defined by the drivetrain device; and
directing a fluid through the radiator, the first fluid path, and the second fluid path to dissipate heat.

18. The method of claim 17, further comprising controlling a temperature of the fluid by providing a thermostat.

19. The method of claim 17, wherein the power electronic device is at least one of an inverter and a chopper.

20. The method of claim 17, wherein the drivetrain device is at least one of a transmission and motor unit, a generator and pump drive unit, and an axle.
